(19) United States
(12) Patent Application Publication
(10) Pub. No.: US 2003/0236925 A1
(43) Pub. Date: Dec. 25, 2003

(54) Interactive portable object adapters support in an integrated development environment

(76) Inventors: Dusan Balek, Bukova (CZ); Karel Gardas, Roznov pod Radhostem (CZ); Tomas Zezula, Novy Malin (CZ)

Correspondence Address: ROSENTHAL & OSHA L.L.P. / SUN, 1221 MCKINNEY, SUITE 2800, HOUSTON, TX, 77010, US

(21) Appl. No.: 09/859,956

(22) Filed: May 17, 2001

(51) Int. Cl. G06F 9/46

(52) U.S. Cl. 709/328; 709/330

(57) ABSTRACT

A method of developing server source code using portable object adapter (POA), includes generating source code representing a POA hierarchy of a server; and propagating changes made to the POA hierarchy automatically to the source code. A computer system adapted to develop server source code using portable object adapter (POA) includes a processor; a memory element, and software instructions for enabling the computer under control of the processor, to perform generation of source code representing a POA hierarchy of a server; and propagate changes made to the POA hierarchy automatically to the source code. A support module for an integrated development environment includes an editor component for writing an interface file; and a portable object adapter (POA) support component that generates source code representing a POA hierarchy of a server. Changes made to the POA hierarchy are automatically propagated to server source code.

### BACKGROUND OF INVENTION

1, Field of the Invention

This invention relates to the field of software development tools for developing distributed object applications.

2, Background Art

Applications developed using distributed objects such as Common Object Request Broker Architecture (CORBA) naturally lend themselves to multi-tiered architecture, fostering a neat separation of functionality. A three-tiered application has a user interface code tier, a computation code (or business logic) tier, and a database access tier. All interactions between the tiers occur via the interfaces that all CORBA objects publish. FIG. 1 illustrates the transition from monolithic applications to multi-tiered, modular applications. A first generation system (2) has a graphical user interface (GUI) (8), a business logic (10), and a data store (12) all combined into one monolithic application. A next generation system (4) has the GUI (8) and the business logic (10) as one application with an interface to the data store (12). A latest generation system (6) has three distinct tiers. A first tier or user interface (UI) tier (20) includes one or more GUI (8), which interface with one or more service logic (13) in a second tier or service tier (22). The service logic (13) in the service tier (22) interfaces with other service logic (13), one or more GUI (8), and one or more data sources (14). A third tier or data store tier (24) includes one or more data sources (14), which interface with one or more service logic (13).

The UI tier is the layer of user interaction. The focus is on efficient user interface design and accessibility. The UI tier can reside on a user desktop, on an Intranet, or on the Internet. Multiple implementations of the UI tier may be deployed accessing the same server. The UI tier usually invokes methods on the service tier and, therefore, acts as a client. The service tier is server-based code with which client code interacts. The service tier is made up of business objects (CORBA objects that perform logical business functions, such as inventory control, budget, sales order, and billing). These objects usually invoke methods on the data store tier objects. The data store tier is made up of objects that encapsulate database routines and interact directly with the database management system product or products.

CORBA is the standard distributed object architecture developed by an Object Management Group (OMG) consortium. The mission of the OMG is to create a specification of architecture for an open software bus, or Object Request Broker (ORB), on which object components written by different vendors can interoperate across networks and operation systems.

The ORB is middleware that establishes the client-server relationships between objects by interacting and making requests to differing objects. The ORB sits between distributed (CORBA) objects in the second tier of the three-tier architecture and operates as a class library enabling low-level communication between parts (objects) of CORBA applications. Programmers usually write applications logic in CORBA and the application logic is then connected to the data store using some other application, e.g., ODBC, JDBC, proprietary, etc. Usually only objects in the application logic communicate using the ORB. Using the ORB, a client transparently invokes a method on a server object, which can be on the same machine or across a network. The ORB intercepts a call and is responsible for finding an object that can implement a request, pass the object a plurality of parameters, invoke the method, and return the results. The client does not have to be aware of where the object is located, the programming language of the object, the operating system of the object, or any other system aspects that are not part of the interface of the object. In other words, the application logic can be run on many hosts in many operating systems and parts of the application logic can be written in different computer languages.

The diagram, shown in FIG. 2, shows a method request (30) sent from a client (32) to an instance of a CORBA object implementation, e.g., servant (36) (the actual code and data that implements the CORBA object) in a server (34). The client (32) is any code that invokes a method on the CORBA object. The client (32) of the CORBA object has an object reference (38) for the object and the client (32) uses this object reference (38) to issue method request (30). If the server object (36) is remote, the object reference (38) points to a stub function (40), which uses the ORB machinery (42) to forward invocations to the server object (36). The stub function (40) encapsulates the actual object reference (38), providing what seems like a direct interface to the remote object in the local environment. The stub function (4C,) uses the ORB (42) to identify the machine that runs the server object and, in turn, asks for that machine's ORB (44) for a connection to the object's server (34). When the stub function (40) has the connection, the stub function (40) sends the object reference (38) and parameters to the skeleton code (46) linked to an implementation of a destination object. The skeleton code (46) transforms the object reference (38) and parameters into the required implementation-specific format and calls the object. Any results or exceptions are returned along the same path.

The client (32) has no knowledge of the location of the CORBA object, implementation details of the CORBA object, or which ORB (44) is used to access the CORBA object. A client ORB (44) and a server ORB (42) communicate via the OMG-specified Internet InterORB Protocol (IIOP) (48). The client (32) may only invoke methods that are specified in the interface of the CORBA object. The interface of the CORBA object is defined using the OMG IDL. CORBA objects can be written in any programming language for which there is mapping from IDL to that language (e.g., Java, C++, C, Smalltalk, COBOL, and ADA). The IDL defines an object type and specifies a set of named methods and parameters, as well as the exception types that these methods may return. An IDL compiler translates the CORBA object's interface into a specific programming language according to an appropriate OMG language mapping.

Referring to FIG. 2, the stub files (40) and skeleton files (46) are generated by an IDL compiler for each object type. Stub files (40) present the client (32) with access to IDL-defined methods in the client programming language. The server skeleton files (46) figuratively glue the object implementation to the ORB (44) runtime. The ORB (44) uses the skeletons (46) to dispatch methods to the servants (36).

Portable Object Adapter (PON) technology is an identifiable entity within the context of a server. Each POA provides a namespace for Object Ids and a namespace for other POAs in the form of nested, or child, POAs. A policy or sets of policies associated with the POA describe characteristics of the objects implemented in that POA. The POA includes numerous components, some of which that are similar to components of the CORBA object model discussed above.

A servant component is a programming language object or entity that implements requests on one or more objects. Servants generally exist within the context of a server process. Requests made on an object's references are mediated by the ORB and transformed into invocations on a particular servant. During an object's lifetime, the object may be associated with multiple servants.

An Object ID component is a value used by the POA and by the user-supplied implementation to identify a specific abstract CORBA object. Object ID values may be assigned and managed by the POA, or they may be assigned and managed by the implementation. Object ID values are encapsulated by references and thus, hidden from clients. The Object ID is a mechanical device used by an object implementation to correlate incoming requests with references the Object ID has previously created and exposed to clients.

An Object Reference encapsulates an Object ID and a POA identity. A concrete reference in a specific ORB implementation contains further information, e.g., the location of the server and POA in question or the full name of the POA.

Referring to FIG. 3, a POA manager (70) is an object that encapsulates the processing state of one or more POAs. Using an operation on the POA manager (70), an application developer (“developer”) can cause requests for the associated POAs to be queued or discarded. Also, the developer can use the POA manager (70) to deactivate the POAs.

A servant manager (72), as shown in FIG. 3, is an object that the developer can associate with the POA. The ORB (not shown) invokes operations on servant managers to activate servants on demand, and to deactivate servants. Servant managers are responsible for managing the association of the object with a particular server and for determining whether the object exists.

An adapter activator is an object that the developer associates with the POA. The ORB invokes an operation on an adapter activator when a request is received for a child POA that does not currently exist resulting in the adapter activator creating the required POA on demand.

POA A technology enables CORBA-based servers to be scalable, object-based server solutions. Developers are allowed to construct object implementations that are portable between different ORB products. Support for objects with persistent identities is, provided and a single servant can support multiple object identities simultaneously. More precisely, POA allows developers to build object implementations that provide consistent service for objects with lifetimes (from the perspective of a client holding a reference for such an object) that span multiple server lifetimes. Multiple distinct instances of the POA are allowed to exist in a server. With POA, object implementations control an object's behavior by establishing the datum that defines an object's identity, determining the relationship between the object's identity and the object's state, managing the storage and retrieval of the object's state, providing the code that will be executed in response to requests, and determining whether the object exists at any point in time. The ORB is not required to maintain persistent state describing individual objects, their identities, where their state is stored, whether certain identity values have been previously used, whether an object has ceased to exist, and so on.

To implement an object using the POA requires the server application to obtain a POA object. As shown in FIG. 3, a distinguished POA object, called a Root POA (50), is managed by the ORB (not shown) and provided to the application using the ORB initialization interface under the initial object name Root POA. The Root POA may also contain an Object Id (66) with a servant pointer (67) pointing to a servant (64).

The developer creates objects using the Root POA (50) if default policies are acceptable. The developer can also create new POAs. In FIG. 3, “POA A” (52) and “POA B” (54) are examples of new POAs. Creating a new POA allows the developer to declare specific policy choices for the new POA and to provide a different adapter activator (74) and servant manager (72) as shown in FIG. 3. The adapter activator (74) and servant manager (72) have object references (68) to other like components on the server. Creating new POAs also allows the developer to partition the name space of objects, as Object Ids are interpreted relative to the POA. For example, “POA A” (52) has a name space of objects, as Object Ids (58), while “POA B” (54) has a separate name space of objects, as Object Ids (60). Finally, by creating new POAs, the developer can independently control request processing for multiple sets of objects.

The POA is created as a child of an existing POA using a create operation on a parent POA. When the POA is created, the POA is given a name that is unique with respect to all other POAs with the same parent. For example, in FIG. 3, “POA C” (56) is created as a child of“POA B” (54). “POA C” (56) may also contain an Object Id (62) with the servant pointer (67) pointing to the servant (64).

POA objects are not persistent and no POA state can be assumed to be saved by the ORB. The server application has the responsibility to create and initialize the appropriate POA objects during server initialization or to set an adapter activator (74) to create POA objects needed later.

Creating the appropriate POA objects is particularly important for persistent objects, i.e., objects whose existence can span multiple server lifetimes. To support an object reference created in a previous server process, the application recreates the POA that created the object reference as well as all of the ancestor POAs. For example, as shown in FIG. 3, a plurality of object references (68) exist between the Root POA (50) and the children of the Root POA (50) (“POA A” (52) and “POA B” (54)). Object references (68) also exist between the Root POA (50), “POA A” (52), “POA B” (54), “POA C” (56), and the POA Manager (70). To ensure portability, each POA is created with the same name as the corresponding POA in the original server process and with the same policies.

A detailed discussion of the POA Specification is beyond the scope of this discussion. For more detailed information, see the Portable Object Adapter Specification at the OMG website (http://www.omg.org).

As illustrated in FIG. 4, Forte™ for Java™ products (90), formerly called NetBeans, are visual programming environments written entirely in Java™. These products are commonly regarded as the leading Integrated Development Environment (IDE). IDEs are easily customizable and extensible, as well as platform independent. Forte™ or Java™ (90) includes a Form Editor (92), an integrated full-featured text editor (94), a debugger (98), and a compiler (100). Forte™ for Java™ (90) is also completely modular. Forte™ for Java™ (90) is built around a set of Open Application Programming Interface (API's) which allow it to be easily extensible. This means that the IDE functionality for editing, debugging, GUI generation, etc. is represented in modules that can be downloaded and updated dynamically as is illustrated in FIG. 4. Instead of waiting for a completely new release, as soon as new versions (104) or new modules (106) are available, users can update that individual version or module via the Update Center (102).

### SUMMARY OF INVENTION

In general, in one aspect, the present invention involves a method of developing server source code using portable object adapter (POA), comprising generating source code representing a POA hierarchy of a server; and propagating changes made to the POA hierarchy automatically to the source code.

In general, in one aspect, the present invention involves a method of developing server source code using portable object adapter (POA), comprising generating source code representing a POA hierarchy of a server; propagating changes made to the POA hierarchy automatically to the source code; adding a POA to server source code; removing a POA from server source code; registering a servant, a servant manager, and a default servant with a POA; unregistering a servant, a servant manager, and a default servant with a POA; managing POA states using a POA manager; managing POA creation using an Adapter Activator; displaying properties of a POA using a property sheet; and changing properties of the POA using a property sheet.

In general, in one aspect, the present invention involves a computer system adapted to develop server source code using portable object adapter (POA), comprising a processor; a memory element, and software instructions for enabling the computer under control of the processor, to perform generation of source code representing a POA hierarchy of a server; and propagate changes made to the POA hierarchy automatically to the source code.

In general, in one aspect, the present invention involves a support module for an integrated development environment, comprising an editor component for writing an interface file; and a portable object adapter (POA) support component that generates source code representing a POA hierarchy of a server. Changes made to the POA hierarchy are automatically propagated to server source code.

In general, in one aspect, the present invention involves a system for developing server source code using portable object adapter (POA), comprising means for generating source code representing a POA hierarchy of a server; and means for propagating changes made to the POA hierarchy automatically to the source code.

Other aspects and advantages of the invention will be apparent from the following description and the appended claims.

### BRIEF DESCRIPTION OF DRAWINGS

FIG. 1 illustrates the transition from monolithic applications to multi-tiered, modular applications.

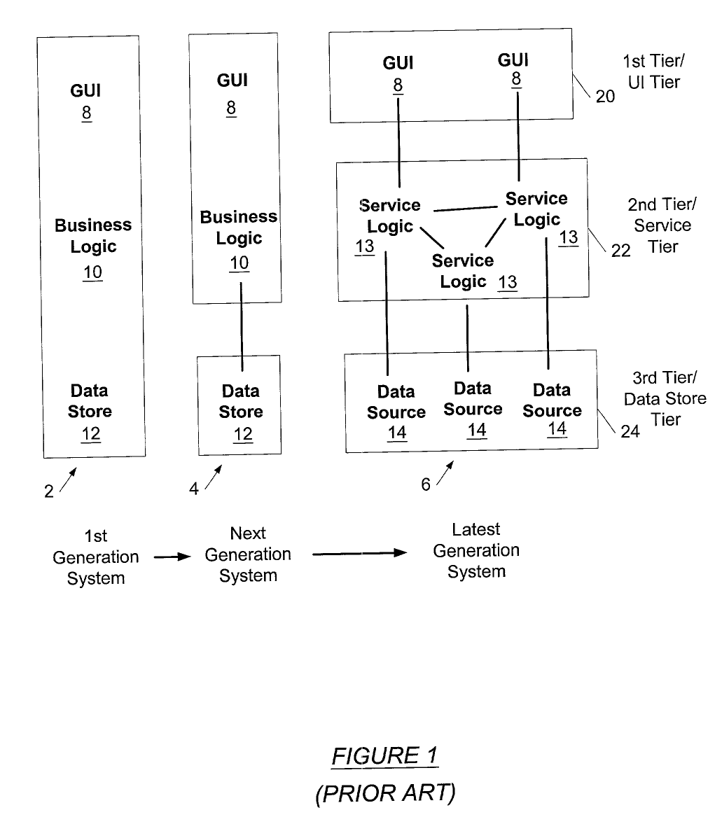

FIG. 2 illustrates a method request sent from a client to a CORBA object implementation in a server.

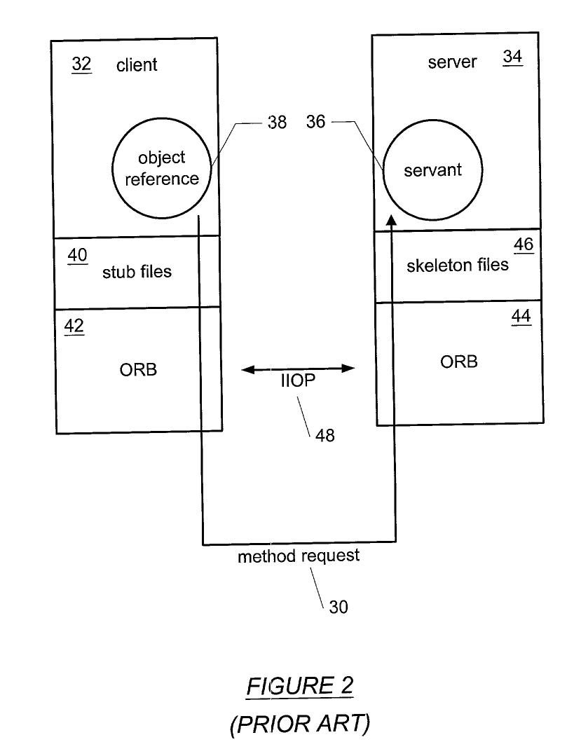

FIG. 3 illustrates a block diagram of POA architecture.

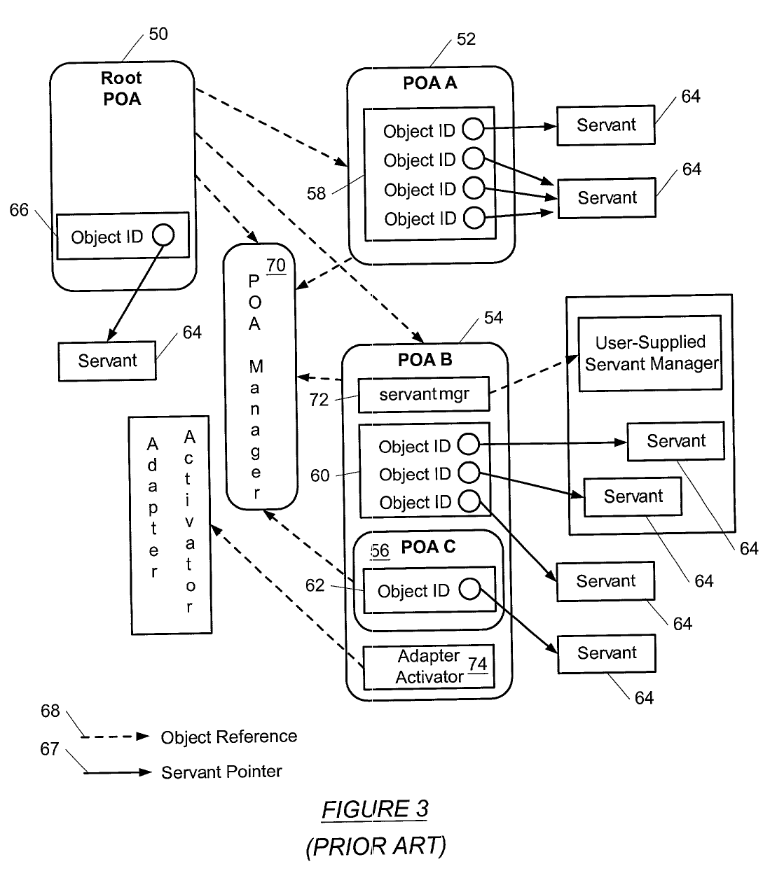

fig. 4 illustrates a Forte™ or Java™ Integrated Development Environment (IDE).

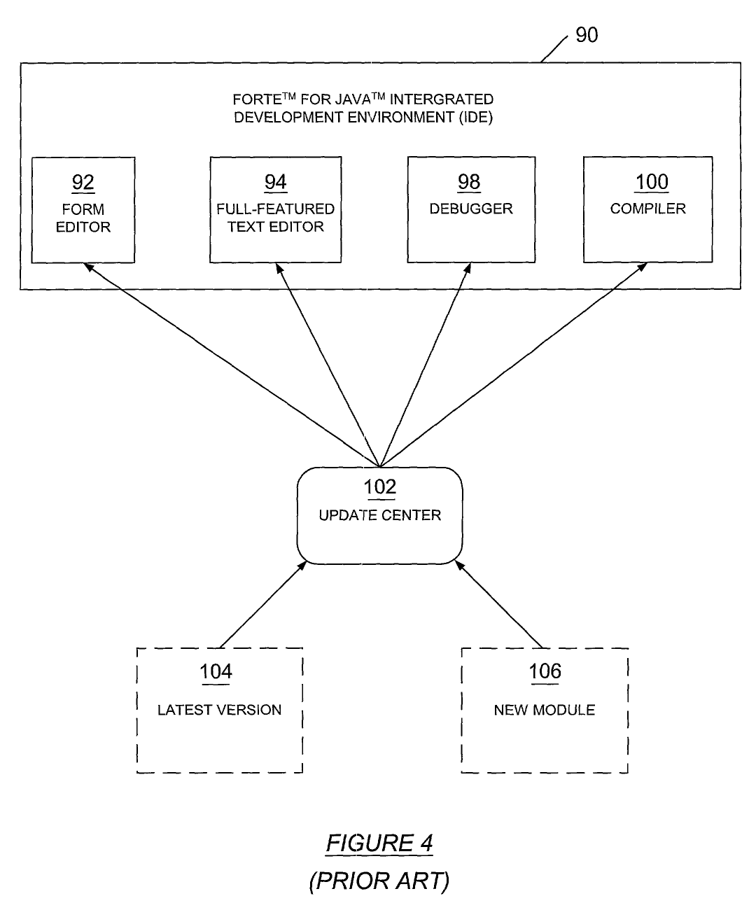

FIG. 5 illustrates a typical computer and its components.

FIG. 6 illustrates a CORBA support module for an IDE in accordance with one or more embodiments of the present invention.

FIG. 7 illustrates a computer screen shot of the Explorer dialog box within Forte™ for Java™ IDE in accordance with one or more embodiments of the present invention.

FIG. 8 illustrates a computer screen shot of the New Child POA dialog box within Forte™ for Java™ IDE in accordance with one or more embodiments of the present invention.

FIG. 9 illustrates a computer screen shot of the Source Editor window showing generated code to create a new POA within the CORBA Support Module of Forte for Java™ IDE in accordance with one or more embodiments of the present invention.

FIG. 10 illustrates a computer screen shot of the New Servant dialog box within Forte™ for Java™ IDE in accordance with one or more embodiments of the present invention.

FIG. 11 illustrates a computer screen shot of the Source Editor window showing generated code to create a new servant within the CORBA Support Module of Forte™ for Java™ IDE in accordance with one or more embodiments of the present invention.

FIG. 12 illustrates a computer screen shot of the Explorer dialog box within Forte™ for Java™ IDE in accordance with one or more embodiments of the present invention.

FIG. 13 illustrates a computer screen shot of the Properties dialog box showing the property sheet within the CORBA Support Module of Forte™ for Java™ IDE in accordance with one or more embodiments of the present invention.

FIG. 14 illustrates a computer screen shot of the Properties dialog box showing the POA policies sheet within the CORBA Support Module of Forte™ for Java™ IDE in accordance with one or more embodiments of the present invention.

FIG. 15 illustrates a computer screen shot of the Properties dialog box showing the ORB sheet within the CORBA Support Module of Forte™ for™ Java IDE in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

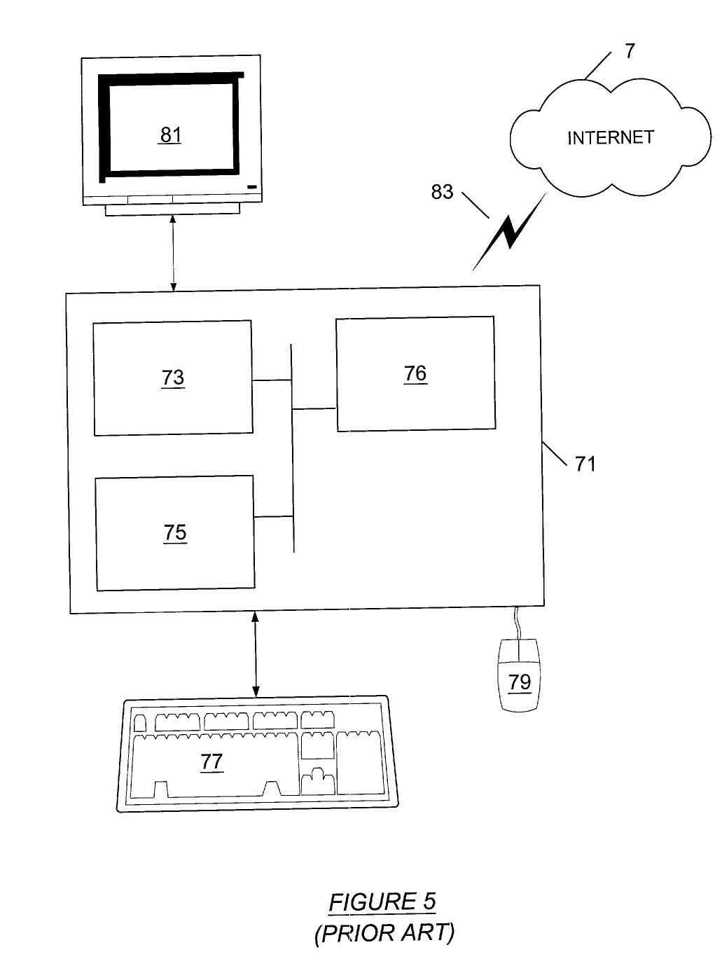

In one aspect, the present invention provides automatic generation of necessary lines of code representing a POA hierarchy of a CORBA server according to information supplied by the developer via a graphical user interface. The invention described here may be implemented on virtually any type computer regardless of the platform being used. For example, as shown in FIG. 5, a typical computer (71) includes a processor (73), an associated memory element (75), a storage device (76), and numerous other elements and functionalities typical to today's computers (not shown). The computer (71) may also include input means, such as a keyboard (77) and a mouse (79), and an output device, such as a monitor (81). Those skilled in the art will appreciate that these input and output means may take other forms. Computer (71) is connected via a connection means (83) to the Internet (7).

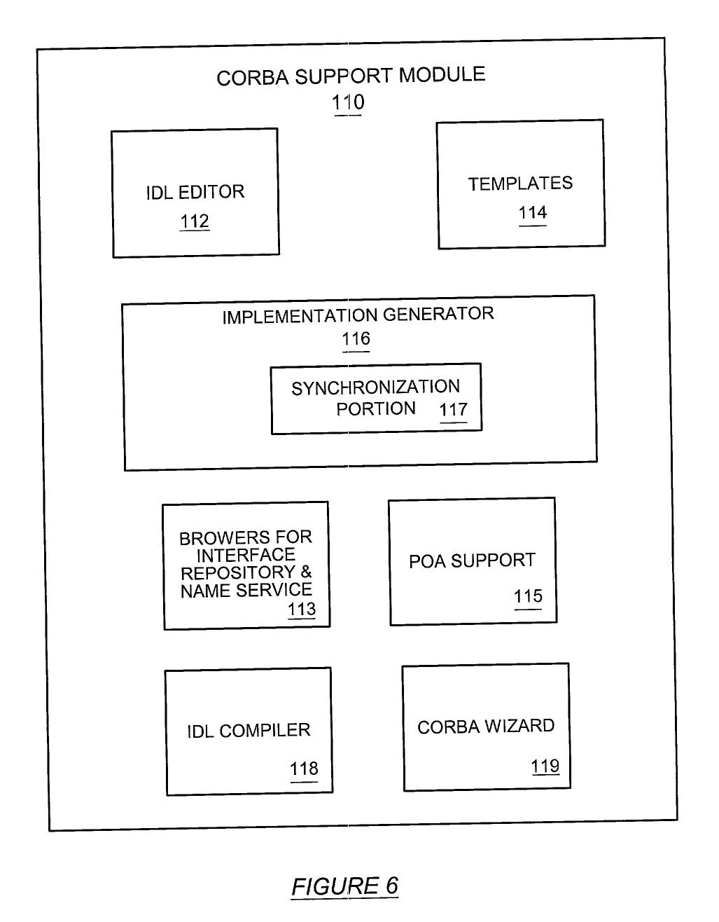

Returning to the Forte™ for Java™ IDE, a POA support component (115) of the CORBA Support Module (110) as shown in FIG. 6 has been created to be used within Forte™ for Java™ or any other IDE to automatically generate code representing a server's POA hierarchy according to information supplied by a developer via a graphical user interface. The support module (110) also provides support for an Interface Definition Language (IDL) editor (112), an IDL compiler (118), a templates (114), and all implementation generator (116) with a synchronization portion (117). Further, the CORBA Support Module (110) includes browsers for interface repository and name service (113), and a CORBA wizard component (119).

Various elements of the CORBA server's source code (e.g., Portable Object Adapters, Servants, Servant Managers, POA Activators, etc.) are represented by nodes in a tree. These nodes are similar to hierarchy attached to a node representing the CORBA server within the IDE. The developer can easily add new nodes to this hierarchy and/or modify the existing nodes using a creation wizard, a property sheet, or a customizer. All changes made to the hierarchy of nodes are automatically propagated to the CORBA server's source code. The graphical user interface ensures that the requirements and constraints placed on a valid CORBA server's source code are satisfied.

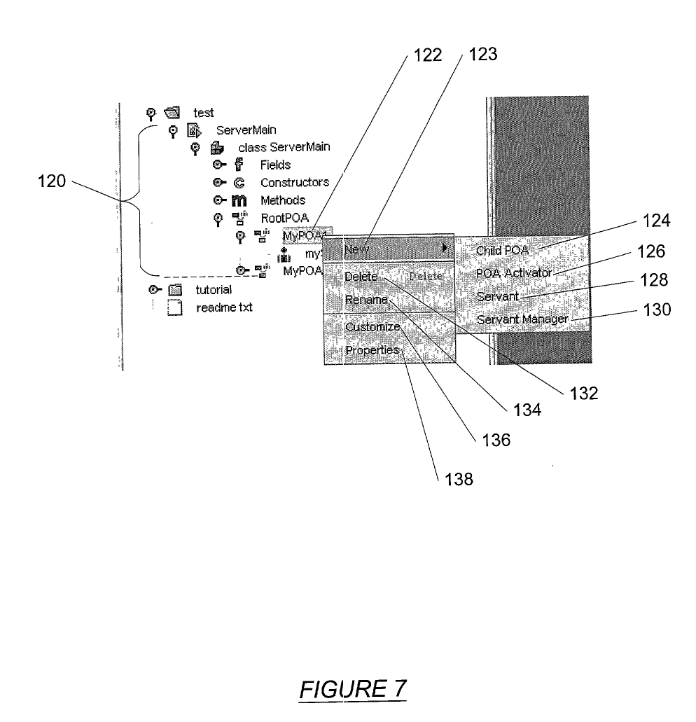

The computer screenshot shown in FIG. 7 illustrates the POA hierarchy (120) added to a Java ClassElementNode in an Explorer feature of the IDE and the action menu items defined on a POANode (122). The action menu items include a New menu item (123); a Delete menu item (132); a Rename menu item (134); a Customize menu item (136); and a Properties menu item (138). The new menu item (123) has a submenu for Child POA (124), POA Activator (126), Servant (128), and Servant Manager (130). Also, there is an additional action, Default Servant (not shown), in the new menu item (123) submenu. The list of submenu items shown depends on selected POA policies and, as there is a mutual exclusion between Servant Manger and Default Servant, both items will not be displayed simultaneously in the submenu of new menu item (123).

The POA Support component of the CORBA Support Module is based on an extended FilterFactory installed with JavaDataObjects. This factory adds a special POANode (representing the root of a server's POA hierarchy, i.e., Root POA) to a Java class element hierarchy of every CORBA server containing POA(s). The criteria used to decide whether a particular Java class element represents a CORBA server containing POA(s) includes three elements. The first element is that the Java class has a main method. The second element is three mandatory guarded blocks contained within the main method body. The first guarded block is poa_section_XXX (where XXX denotes the ORB's tag) and is designed to wrap code for the POA creation. The second guarded block is servant_section and is designed to wrap code for creating and activating servants, servant managers, default servants, and POA activators. The third guarded block is poa_activate_section and is designed to wrap code for POA activation. The third element is that the method call orb.resolve_initial_references(“RootPOA”) is present within the poa_section_XXX guarded block. If one of the ORBs supporting POA as the active ORB (using CORBA settings) is selected, then every Java class created from CORBA/ServerMain and CORBA/CallBackClient templates complies with the above mentioned criteria.

A POA hierarchy within the Explorer feature of the IDE reflects a static hierarchy of POAs within a CORBA server. It is formed by nodes of several types, including POANodes representing POAs, ServantNodes representing servants registered with POAs, ServantManagerNodes representing servant managers registered with POAs, DefaultServantNodes representing default servants registered with POAs, and POAActivatorNodes representing POA activators. Code generated from the POA hierarchy resides in guarded blocks located on dedicated places within the main method of a CORBA server.

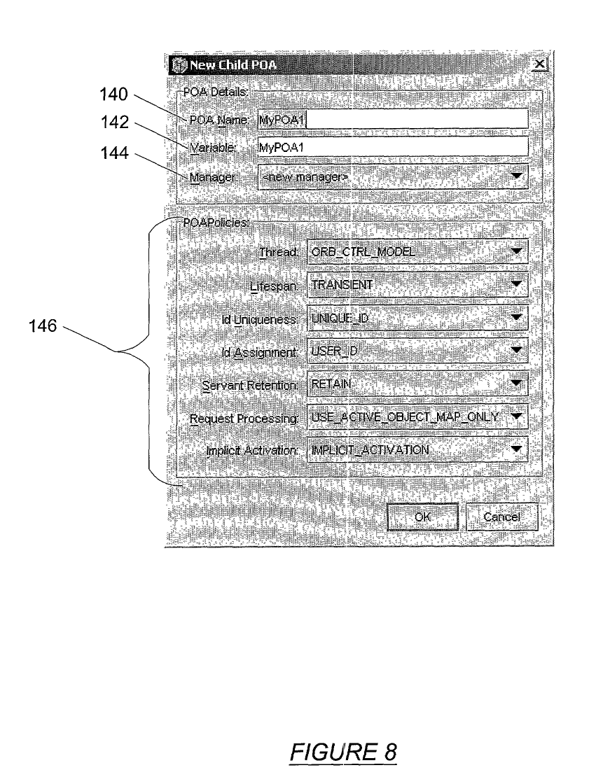

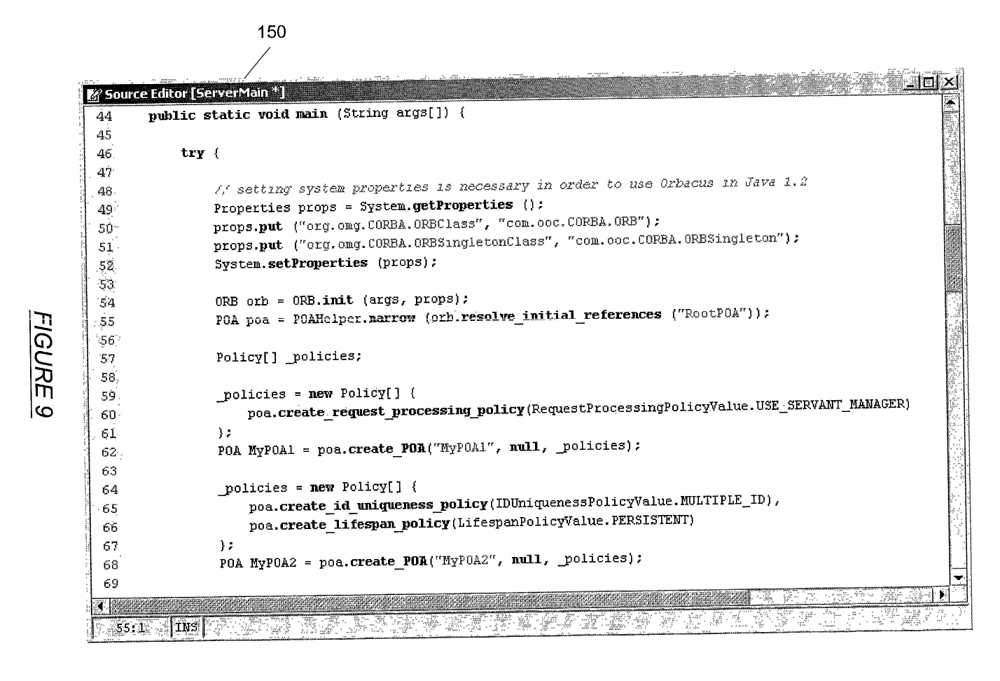

The POA Support component of the CORBA Support Module provides support for adding/removing a POA to/from a server code (including interactive setup of POA policies). Referring back to FIG. 7, a new POA can be added to a parent POA by selecting the action menu item New (123) and submenu Child POA (124) on the POANode representing the parent POA. As the result of this action, a standard dialog box New Child POA for specifying POA name (140), variable name (142), manager (144), and policies (146) appears as shown in FIG. 8. After providing the requested information, source code is generated and placed into a dedicated guarded block located within a server's main method (150) as shown in FIG. 9.

Referring again to FIG. 7, the POA can be removed from the POA hierarchy by selecting the action menu item Delete (132) on the POANode representing the POA. If there are any child elements (e.g., POAs, servants, servant managers, etc.) registered with the POA being removed, a standard dialog box appears to warn the developer and to request approval for the action. When the POA is removed all the child elements are removed as well.

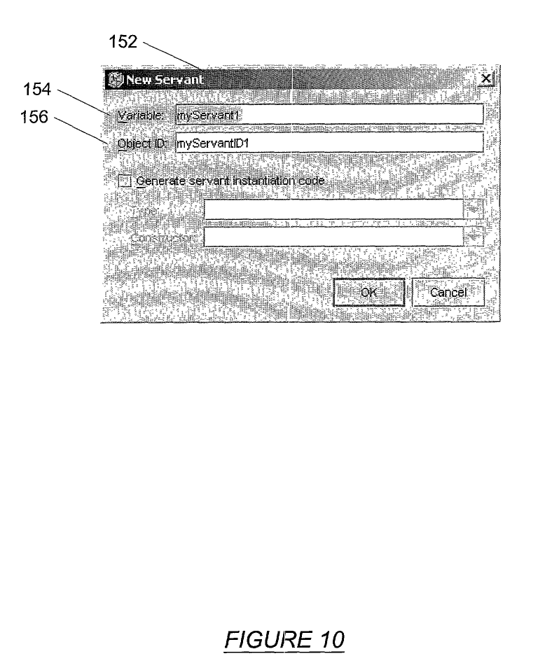

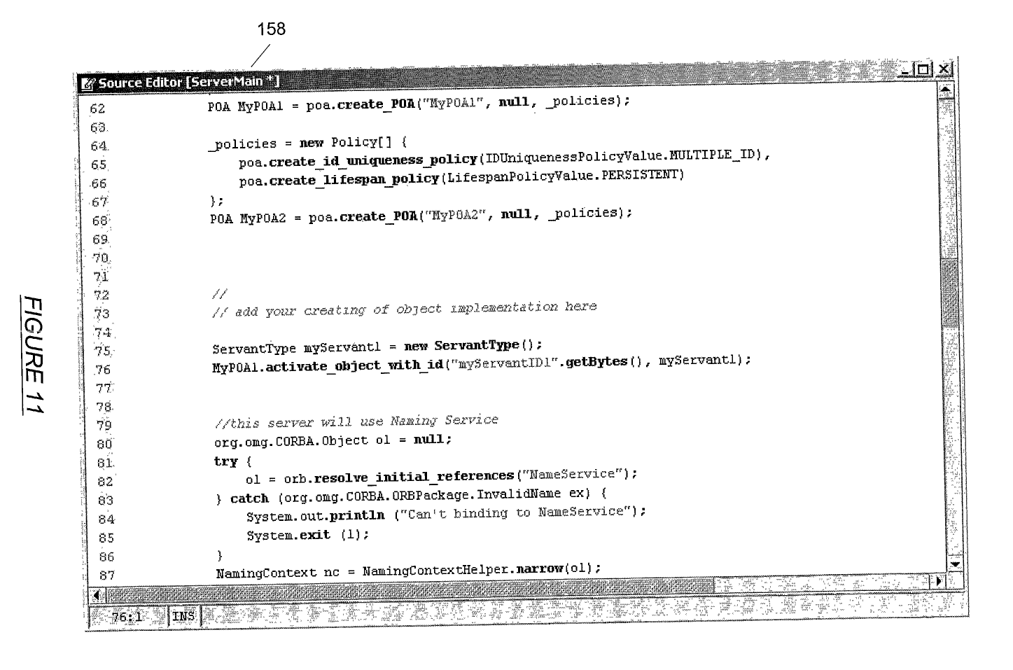

The POA Support component of the CORBA Support module provides support for registering/unregistering servants, servant managers, and default servants with a POA. Referring back to FIG. 7, a new servant is registered and added to the parent POA by selecting the action menu item New (123) and submenu Servant (128) on the POANode representing the parent POA. As a result of this action, a standard dialog box entitled New Servant (152) appears for specifying servant's Object ID (156) and variable name (154) appears as shown in FIG. 10. After providing the requested information, source code is generated in the Source Editor (158) and placed into a dedicated guarded block located within the server's main method as shown in FIG. 11. In one or more embodiments of the present invention, the POA Support component of the CORBA Support module provides support POA Activators, Servant Managers, and Default Servants, which are registered with the POA similarly to the description above on registering the servant.

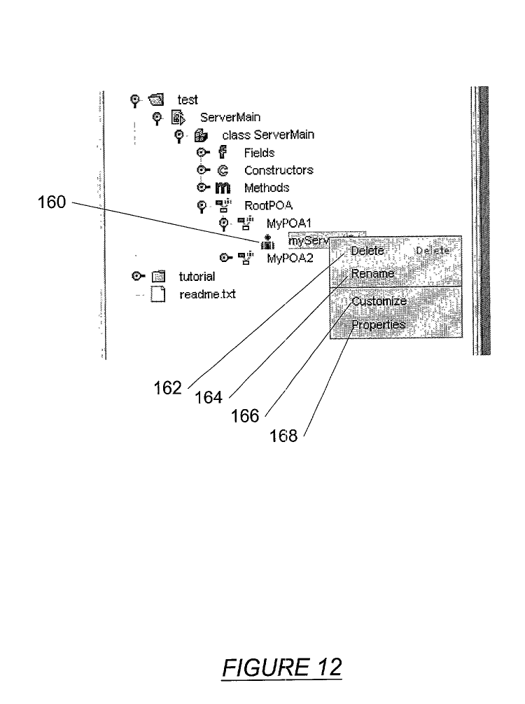

FIG. 12 illustrates the actions defined on a newly created ServantNode (160) in the Explorer feature of the IDE, including an action Delete (162) menu item, an action Rename (164) menu item, an action Customize (166) menu item, and an action Properties (168) menu item. Once created, POAActivatorNodes, ServantManagerNodes, and DefaultServantNodes have the same set of actions as shown in FIG. 12 for the ServantNode (160).

The servant can be unregistered from a POA by selecting the action menu item Delete (162) on ServantNode (160) representing a particular servant as shown in FIG. 12. Next, a standard dialog box appears to request the developer's approval for the action (not shown). The POA Support component of the CORBA Support Module provides support for POA activators, servant managers, and default servants to be unregistered from the POA similarly to description above on unregistering the servant. The POA Support component of the CORBA Support Module provides support for managing POA(s) states using one or more POA Managers and provides support for managing POA(s) creation using one or more adapter activators,

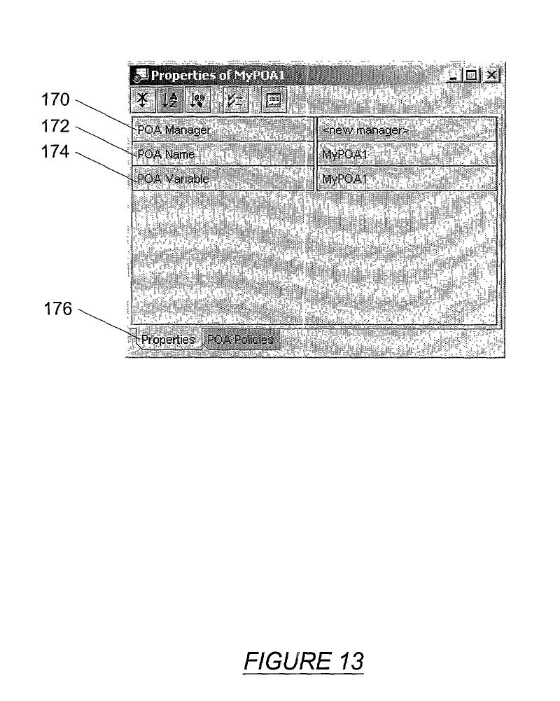

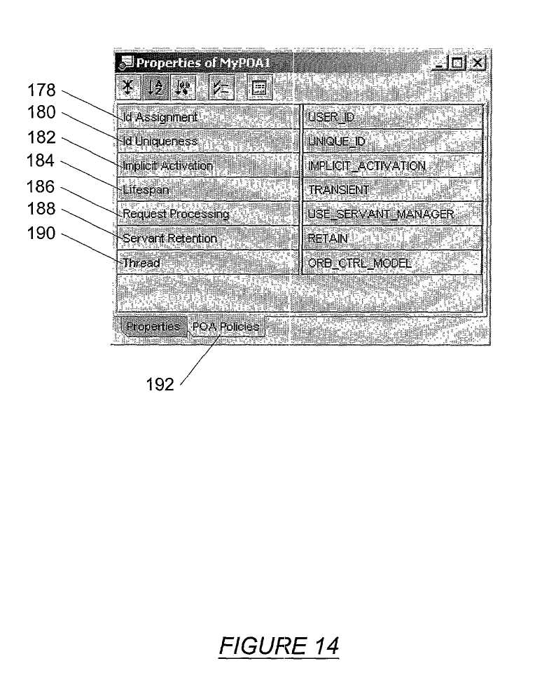

The POA Support component of the CORBA Support Module provides support for displaying and changing properties of a POA using a property sheet. The developer can view and change properties of the POA using the read/write property sheet that is displayed after invoking the Properties (168) action menu item on the corresponding POANode (160) as shown in FIG. 12. Referring to FIG. 13, the property sheet entitled Properties (176) includes several fields of the properties of the POANode, including POA Manager (170), POA Name (172), and POA Variable (174). Referring to FIG. 14, the property sheet entitled POA Policies (192) includes several fields of the properties of the POANode, including Id Assignment (178), Id Uniqueness (180), Implicit Activation (182), Lifespan (184), Request Processing (186), Servant Retention (188), and Thread (190).

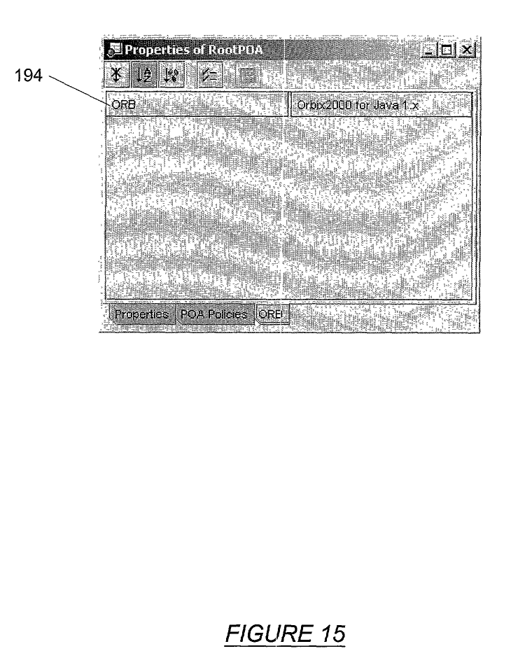

As shown in FIG. 15, the Root POA has an additional property that identifies the ORB (194) used to create the POA hierarchy under this root. If this ORB (194) does not correspond to a current ORB set by the user, the POA hierarchy is presented as read-only (as POA hierarchies created by different ORBs may differ slightly). Setting the ORB property (194) of the Root POA to another value results in the POA hierarchy to be transformed . In certain situations, some information may be lost during this operation.

Advantages of the present invention may include one or more of the following. Providing the developer POA support within the IDE allows the developer to create the CORBA server in one environment. The potential for mistakes is reduced and the total development process is sped up. Providing POA support via the graphical user interface further reduces errors in coding because a structured graphical form is used. The POA support feature of the CORBA Support module also provides consistency in the code generation for POA support. Those skilled in the art will appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of developing server source code using portable object adapter (POA), comprising:
generating source code representing a POA hierarchy of a server; and
propagating changes made to the POA hierarchy automatically to the source code.

2. The method of claim 1, further comprising:
receiving the changes made to the POA via a graphical user interface.

3. The method of claim 1, wherein developing server source code occurs within an integrated development environment.

4. The method of claim 1, wherein changes are made to the POA hierarchy using a creation wizard.

5. The method of claim 1, wherein changes are made to the POA hierarchy using a property sheet.

6. The method of claim 1, wherein changes are made to the POA hierarchy using a customizer.

7. The method of claim 1, wherein the POA hierarchy comprises a plurality of nodes.

8. The method of claim 1, wherein the POA hierarchy resides in a guarded block located within a main method of a server.

9. The method of claim 1, further comprising:
adding a POA to server source code.

10. The method of claim 1, further comprising:
removing a POA from server source code;

11. The method of claim 1, further comprising:
registering a servant, a servant manager and a default servant with a POA.

12. The method of claim 1, further comprising:
unregistering a servant, a servant manager and a default servant with a POA.

13. The method of claim 1, further comprising:
managing POA states using a POA manager.

14. The method of claim 1, further comprising:
managing POA creation using an Adapter Activator.

15. The method of claim 1, further comprising:
displaying properties of a POA using a property sheet.

16. The method of claim 1, further comprising:
changing properties of the POA using a property sheet.

17. A method of developing server source code using portable object adapter (POA), comprising:
generating source code representing a POA hierarchy of a server;
propagating changes made to the POA hierarchy automatically to the source code;
adding a POA to server source code;
removing a POA from server source code;
registering a servant, a servant manager, and a default servant with a POA;
unregistering a servant, a servant manager, and a default servant with a POA;
managing POA states using a POA manager;
managing POA creation using an Adapter Activator;
displaying properties of a POA using a property sheet; and
changing properties of the POA using a property sheet.

18. The method of claim 17, further comprising:
receiving the changes made to the POA via a graphical interface.

19. The method of claim 17, wherein developing server source code occurs within an integrated development environment

20. A computer system adapted to develop server source code using portable object adapter (POA), comprising:
a processor;
a memory element, and
software instructions for enabling the computer under control of the processor, to perform generation of source code representing a POA hierarchy of a server; and
propagate changes made to the POA hierarchy automatically to the source code.

21. The system of claim 20, further comprising:
a graphical interface for making changes to the POA.

22. The system of claim 20, further comprising:
an integrated development environment within which the generation occurs.

23. The system of claim 20, further comprising:
a creation wizard for changing the POA hierarchy.

24. The system of claim 20, further comprising:
a property sheet for changing the POA hierarchy.

25. The system of claim 20, further comprising:
a customizer for changing the POA hierarchy.

26. The system of claim 20, the POA hierarchy comprising:
a plurality of nodes.

27. A support module for an integrated development environment, comprising:
an editor component for writing an interface file; and
a portable object adapter (POA) support component that generates source code representing a POA hierarchy of a server;
wherein, changes made to the POA hierarchy are automatically propagated to server source code.

28. The support module of claim 27, further comprising:
a graphical interface for inputting changes to the POA.

29. The system of claim 27, further comprising:
a creation wizard for changing the POA hierarchy.

30. The system of claim 27, further comprising:
a property sheet for changing the POA hierarchy.

31. The system of claim 27, further comprising:
a customizer for changing the POA hierarchy.

32. The system of claim 27, the POA hierarchy comprising:
a plurality of nodes.

33. A system for developing server source code using portable object adapter (POA), comprising:
means for generating source code representing a POA hierarchy of a server; and
means for propagating changes made to the POA hierarchy automatically to the source code.
